(19) United States
(12) Patent Application Publication
(10) Pub. No.: US 2024/0347686 A1
(43) Pub. Date: Oct. 17, 2024

(54) EVALUATION SYSTEM FOR DRY ELECTRODE MIXTURE OF VEHICLE BATTERY

(71) Applicants: Hyundai Motor Company, Seoul (KR); Kia Corporation, Seoul (KR)

(72) Inventors: Hyun Jin Kim, Daegu (KR); Geun Ho Choi, Suwon (KR); Han Nah Song, Suwon (KR)

(73) Assignees: Hyundai Motor Company, Seoul (KR); Kia Corporation, Seoul (KR)

(21) Appl. No.: 18/370,176

(22) Filed: Sep. 19, 2023

(30) Foreign Application Priority Data
Apr. 11, 2023 (KR) 10-2023-0047180

(51) Int. Cl. H01M 4/04; H01M 4/62

(52) U.S. Cl. CPC H01M 4/04; H01M 4/621; H01M 2220/20

(57) ABSTRACT

A vehicle such as an electric vehicle may include a battery such as a secondary battery that includes an electrode manufactured using a dry process. A system for evaluating a dry electrode mixture of the battery includes a manufacturing apparatus configured to form a film of the dry electrode mixture, the dry electrode mixture being a mixture of an electrode active material, a conductive additive, and a binder, a microscope configured to obtain a target image of the dry electrode mixture supplied from the manufacturing apparatus, and a computer operably connected to the microscope, the computer configured to analyze the target image obtained from the microscope and determine whether the binder in the dry electrode mixture is fiberized.

### CROSS-REFERENCE TO RELATED APPLICATION

This application claims under 35 U.S.C. § 119 (a) the benefit of Korean Patent Application No. 10-2023-0047180, filed on Apr. 11, 2023, the entire contents of which are incorporated herein by reference.

### BACKGROUND

### (a) Technical Field

The present disclosure relates to manufacture of a battery for a vehicle, more particularly, to an evaluation system for manufacturing a dry electrode for the battery of the vehicle such as an electric vehicle.

### (b) Description of the Related Art

Recently, a rechargeable secondary battery is expanding its application in various fields from a small electronic device to a large energy storage system. Particularly, with the rapid growth of the electric vehicle market, research and development on the secondary battery is being actively conducted.

The electrode of the secondary battery has been generally manufactured through a wet process. In the wet process, electrode material, binder, and conductive additive contained in the electrode are dissolved in a solvent to prepare a slurry. Alternatively, a dry process is performed without using a solvent, which is needed in the wet process, and the dry process is capable of increasing an energy density of a battery compared to the wet process.

In the dry process of manufacturing an electrode, electrode active material, conductive additive, and binder are mixed without a solvent to form a mixture, and then the mixture is formed into a dry electrode film using a press or calendaring method. The dry electrode film is attached to a current collector, and manufacturing of the electrode is completed.

Because the manufacturing of the electrode using the dry process is in early stages of technological development, there is no standard technique to evaluate quality of the electrode. For this reason, if a defect is found in a final stage of the manufacturing process, it is typically necessary to return to the first stage to solve the defect, thus increasing material costs and time in the manufacturing process.

The above information disclosed in this Background section is only for enhancement of understanding of the background of the disclosure, and therefore it may contain information that does not form the prior art that is already known to a person of ordinary skill in the art.

### SUMMARY

The present disclosure provides an evaluation system for analyzing a dry electrode mixture, which is capable of effectively determining whether binder is fiberized when manufacturing a dry electrode.

In one aspect, the present disclosure provides a system for evaluating a dry electrode mixture, the system including a manufacturing apparatus configured to form a film of the dry electrode mixture, the dry electrode mixture being a mixture of an electrode active material, a conductive additive, and a binder, a microscope configured to obtain a target image of the dry electrode mixture supplied from the manufacturing apparatus, and a computer operably connected to the microscope, the computer configured to analyze the target image obtained from the microscope and determine whether the binder in the dry electrode mixture is fiberized.

In another aspect, the present disclosure provides a system for evaluating a dry electrode mixture, the system including a microscope configured to obtain a target image of the dry electrode mixture supplied thereto, the dry electrode mixture being a mixture of an electrode active material, a conductive additive, and a binder, and a computer operably connected to the microscope, the computer configured to receive the target image from the microscope, the computer being configured to analyze the target image obtained from the microscope and determine whether the binder in the dry electrode mixture is fiberized.

The computer may be configured to output a result indicating whether the binder in the dry electrode mixture is fiberized.

For example, when the binder is determined to be fiberized, the analyzed dry electrode mixture may be introduced back into the manufacturing apparatus and used for manufacturing a dry electrode.

A battery for a vehicle (e.g., an electric vehicle) may be produced from the above-described system. The battery may be a secondary battery for the electric vehicle.

A vehicle may include the battery as described above.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 schematically illustrates a fibrous degree of binder in a dry electrode mixture;

FIG. 2 illustrates an evaluation system for analyzing a dry electrode mixture according to the present disclosure;

FIG. 3 is a plan view of the evaluation system for analyzing the dry electrode mixture of FIG. 2;

FIG. 4 illustrates a classification example of indication values indicating the fibrous degree of binder;

FIG. 5 illustrates a learning process on the fibrous degree of binder according to some embodiments of the present disclosure; and

FIG. 6 is a flow chart for evaluation of a dry electrode mixture according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and usage environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” another component, the component may be directly connected to the other component, or intervening components may also be present. In contrast, when a component is referred to as being “directly connected to” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure will be described in detail with reference to the accompanying drawings.

A dry electrode for a battery (e.g., a secondary battery of an electric vehicle) may be made from a dry electrode mixture and a current collector. The dry electrode may be manufactured in such a manner that the dry electrode mixture is introduced into a manufacturing apparatus 10, which is a film-forming facility, to be formed into a dry electrode film through a film forming process, and the dry electrode film is attached or laminated to the current collector.

The dry electrode mixture comprises an electrode active material 2, a conductive additive 4, and a binder 6. The dry electrode mixture is prepared by mixing the electrode active material, the conductive additive, and the binder using a mixer. As a non-limiting example, the dry electrode mixture may be prepared by a high shear mixer using rotation or a fluid mixer using air.

According to an embodiment of the present disclosure, for a lithium-ion battery, the dry electrode mixture may contain 90 to 99% by weight of electrode active material, 0.01 to 5% by weight of conductive additive, and 0.01 to 5% by weight of binder. According to another embodiment of the present disclosure, for an all-solid-state battery, the dry electrode mixture may contain 70 to 99% by weight of electrode active material, 0.01 to 30% by weight of solid electrolyte, 0.01 to 5% by weight of conductive additive, and 0.01 to 5% by weight of binder. According to the present disclosure, the dry electrode may be a cathode or an anode.

In some embodiments, when the cathode is prepared, the electrode active material comprises a cathode active material. As a non-limiting example, the cathode active material may be nickel manganese cobalt (NMC) series, lithium ferrophosphate (LFP), lithium cobalt (LCO), or sulfur. In some embodiments, when the anode is prepared, the electrode active material comprises an anode active material. As a non-limiting example, the anode active material is graphite series and may comprise silicon.

The conductive additive may comprise a carbon-based material. In addition, for a dry electrode of an all-solid-state battery, the dry electrode mixture may further comprise a polyethylene oxide (PEO)-based polymer and an oxide-based and sulfide-based solid electrolyte. The binder may comprise polytetrafluoroethylene (PTFE), polyvinylidene fluoride (PVDF), or styrene butadiene rubber (SBR).

In manufacturing a dry electrode, fiberization of the binder in the dry electrode mixture is crucial. When the binder is not properly fiberized in the dry electrode mixture, it is not possible to manufacture a dry electrode. Moreover, when the binder is agglomerated in the dry electrode mixture, the interfacial resistance at a specific area increases, which adversely affects the characteristics of the battery.

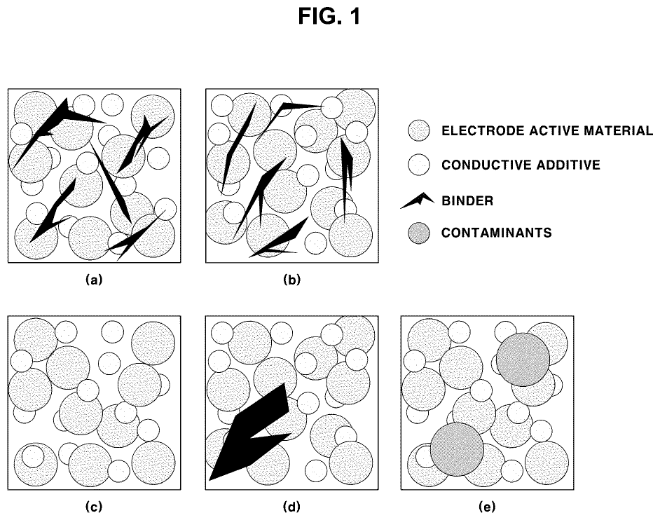

As illustrated in FIG. 1, images (a) and (b) show a dry electrode mixture M in which the binder is properly fiberized. In this case, measurements on several areas in the dry electrode mixture M show a similar dispersion degree of binder. However, when the dry electrode mixture M is not properly mixed due to an insufficient shear force of the mixer, only the electrode active material and the conductive additive can be observed because the binder is not dispersed but agglomerated somewhere, as in image (c). In addition, agglomerated binder may also be observed, as in image (d). In such cases, the dry electrode mixture M may not formed into a film or a dry electrode film exhibits non-uniformity. Instead, as shown in image (e), contaminants introduced into a hopper in the manufacturing apparatus 10 for the dry electrode mixture M may be observed.

The fibrous degree of binder may be observed by a microscope, such as an electron microscope or an optical microscope. However, a dry electrode production line is not provided with a microscope to analyze the fiberization of the binder, so a sample has to be transported to an analysis laboratory for analysis using a microscope. For this reason, the present disclosure proposes an evaluation system for a dry electrode mixture integrated with a dry electrode production line to reduce time and cost.

In addition, according to the present disclosure, the fibrous degree of binder measured in the evaluation system may be determined by a trained machine learning model, and feedback thereof may be provided immediately to an operator.

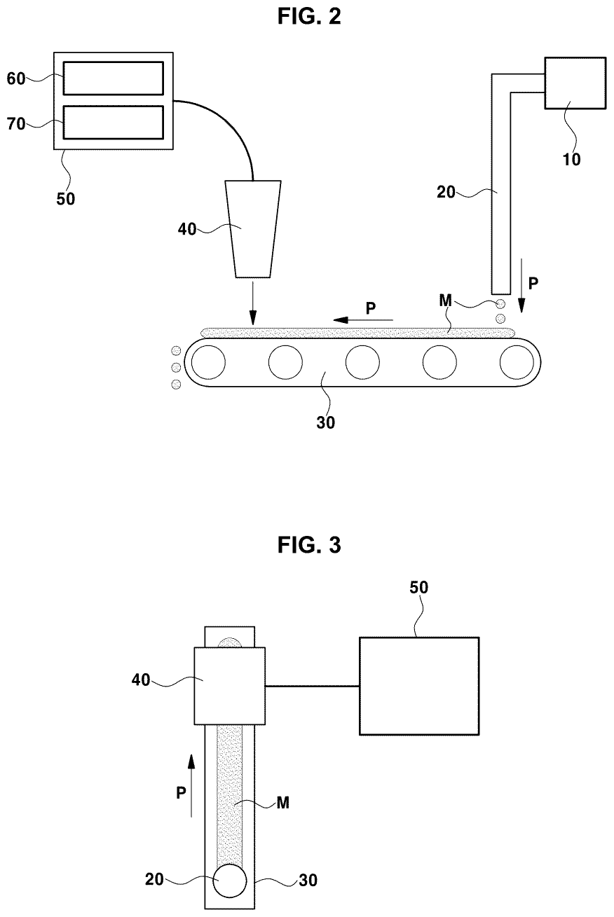

As illustrated in FIGS. 2 and 3, the evaluation system for the dry electrode mixture M according to the present disclosure is connected to the manufacturing apparatus 10, which is an apparatus of forming a film. In some embodiments, the manufacturing apparatus 10 may be provided with a supply channel 20. Through the supply channel 20, a portion of the dry electrode mixture M produced in the manufacturing apparatus 10 may be supplied. For example, the supply channel 20 may be provided in a hopper or a buffer space where the dry electrode mixture M is introduced into the manufacturing apparatus 10.

The dry electrode mixture M distributed through the supply channel 20 is supplied to a conveyor 30. The dry electrode mixture M is conveyed through the conveyor 30. The speed of the conveyor 30 may be adjusted. For example, the speed of the conveyor 30 may be set to 0.1 to 10 meters per minute.

A microscope 40 is disposed downstream of the supply channel 20 with respect to a flow direction P of the dry electrode mixture M. The microscope 40 may be configured to observe and capture the image of the dry electrode mixture M conveyed through the conveyor 30. As a non-limiting example, the microscope 40 may be an optical microscope or a scanning electron microscope. However, the microscope 40 is not limited thereto, and the type thereof may be selected depending on the scale of the controlled fibrous degree of material. The conveyor 30 may be controlled to stop when the microscope 40 observes the dry electrode mixture M and obtains the image thereof.

The dry electrode mixture M supplied from the manufacturing apparatus 10 through the supply channel 20 may move in the flow direction P. Specifically, the dry electrode mixture M is conveyed to the conveyor 30 through the supply channel 20 in the flow direction P and is analyzed by the microscope 40. The dry electrode mixture M is not consumed for the analysis but is directed back to the manufacturing apparatus 10 to be used in manufacturing a dry electrode.

An image captured by the microscope 40 is transmitted to a computer 50. Particularly, the captured image may be stored in a storage device 60. The storage device 60 may be provided inside or outside the computer 50. The computer 50 is configured to communicate with the storage device 60 and obtain an image from the storage device 60.

The computer 50 is configured to obtain an image stored in the storage device 60 or an image received from the microscope 40 to process the obtained image as data. Particularly, the computer 50 may analyze the fiberization of the binder in the dry electrode mixture M based on the received image.

To this end, the computer 50 is configured to execute machine learning algorithms. The computer 50 may be trained using a machine learning model 70. As a non-limiting example, logistic regression, random forest, neural network, etc., may be used as the machine learning model 70. Preferably, a model showing the largest value in an area under a receiver operating characteristic (ROC) curve (AUC) may be selected depending on the obtained data.

The computer 50 may obtain a low-dimensional feature vector for the image of the dry electrode mixture M through image embedding. As a non-limiting example, Inception V3 may be used as an image embedder.

The machine learning model 70 may take the feature vector of each image as an input and output an indication value n indicating the fibrosis degree of binder in the dry electrode mixture M in each image as an output.

The machine learning model 70 may be trained to output an indication value indicating the fiberization of binder by inputting the feature vector of an image. The machine learning model 70 is trained based on the image of the dry electrode mixture M in which the fiberization of the binder is known. For example, the machine learning model 70 may be trained by taking a feature vector as an input (feature) and an indication value n, which is an integer defined based on the thickness of the binder in the image, as an output (target).

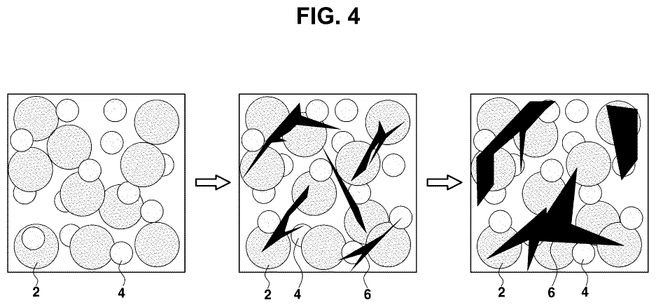

According to an embodiment of the present disclosure, the indication value n may be set to an integer indicating the fibrous degree of binder. For example, the fibrous degree may be obtained as 0 and an integer, e.g., 1 or greater. When fiberization of the binder is not observed in the mixture M, the indication value is 0, and the shorter length of the horizontal and vertical lengths of the observed binder is set as the thickness of the binder. In this way, when the thickness is 0.1 micrometer or greater and less than 10 micrometers, the indication value n may be set to 1, when the thickness is 10 micrometers or greater and less than 20 micrometers, the indication value n may be set to 2, and when the thickness is 20 micrometers or greater and less than 30 micrometers, the indication value n may be set to 3. For example, referring to FIG. 4, when the binder is not observed, the indication value n may be set to 0 (on the left of FIG. 4). When the binder is observed and the thickness thereof is 0.1 micrometer or greater and less than 10 micrometer, the indication value n may be set to 1 (in the middle of FIG. 4). When the binder is observed and the thickness thereof is 10 micrometers or greater and less than 20 micrometers, the indication value n may be set to 2 (on the right of FIG. 4). As such, whether binder is fiberized or the fibrous degree thereof may be determined by adjusting the range of the thickness of the binder indicated by each indication value n.

The thickness of the binder in which fiberization thereof is known may be measured using the image obtained by the microscope 40. In addition, the thickness of the binder may be measured based on the average thickness in one image. Specifically, the thickness of the binder may be measured from one obtained image, and the thicknesses of as many areas as possible on each binder may be measured. The thicknesses of the binder measured in this way may form a normal distribution. The mean value from the normal distribution is defined as a desired thickness of the binder. When determined that similar form of fiberization is made in a random image, even if a binder having a thickness measured to be slightly greater or smaller than the average thickness is contained, it may be assumed that the binder has a fibrosis degree same as that of a binder having the average thickness. However, even if a normal distribution is formed, when binder is agglomerated to a large size as in image (d) of FIG. 1, the binder is defined as belonging to the category of poorly distributed binder, and the definition is trained into the machine learning model.

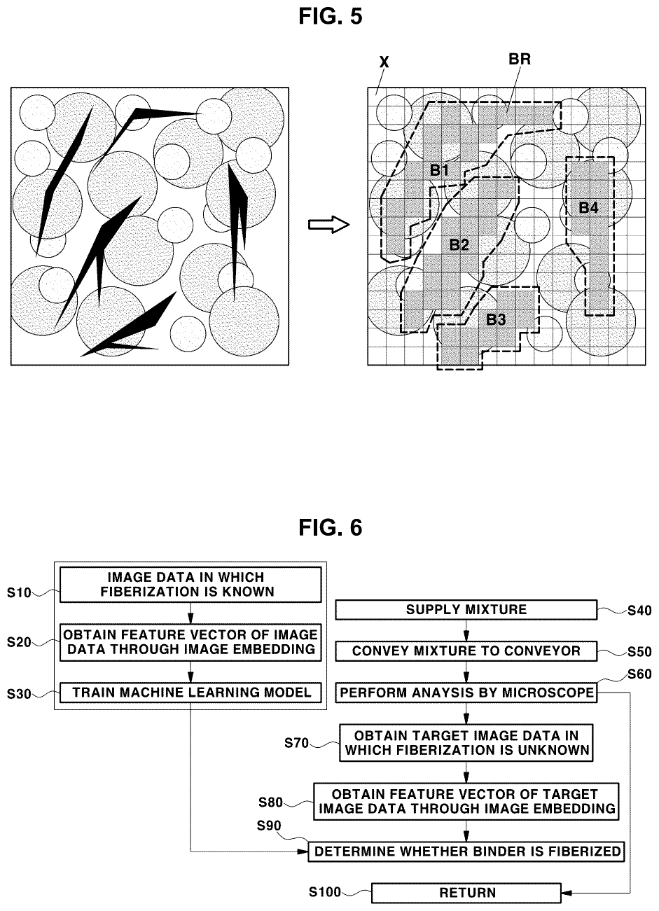

According to another embodiment of the present disclosure, the machine learning model 70 may be trained to determine the fibrous degree based on the number, size, or area of binders occupying the image measured by the microscope 40. More specifically, as illustrated in FIG. 5, the image in which the fibrous degree of binder is measured by the microscope 40 is converted into a unit of a pixel X. The image on the right of FIG. 5 is an image in which the image on the left of FIG. 5, which corresponds to FIG. 1 image (b), is divided into a plurality of pixels X.

The pixel X including the binder (BR, shaded section) is defined as 1, and the pixel X not including binder (unshaded section) is defined as 0. Pixel sections (i.e., B1, B2, B3, and B4) continuously valued as 1 are recognized as one binder. The area of each pixel section (i.e., the number of pixels X) is defined as the fibrous degree of binder. Thus, an average value of the area of each pixel section (i.e., the number of pixels X) is calculated, and the average value is determined as the fibrous degree of binder represented from one image.

Taking FIG. 5 as an example, FIG. 5 is an image of a mixture having a satisfactory degree of dispersion of binder, including four pixel sections B1, B2, B3, and B4. The pixel section B1 includes nineteen pixels, the pixel section B2 includes eighteen pixels, the pixel section B3 includes ten pixels, and the pixel section B4 includes twelve pixels. Dividing the sum of the number of pixels, 59, by the number of binders, 4, yields an average value of 14.75. The average value is set as a satisfactory range. When an image to be analyzed is input, the machine learning model 70 may recognize the pixel sections including the binder and the number of the pixels in each pixel section to yield the average value to thereby determine the dispersion degree of binder. In addition, the machine learning model 70 may also recognize and determine the number of pixels for additional materials, such as, electrode active material and conductive additive, in the same manner used for binder.

Although there are actually five binders in the image on the left of FIG. 5 (FIG. 1 image (b)), the number of binders may be recognized to be four depending on the method of defining the section of pixels X. As the number of pixels X divided from the entire image increases, the accuracy increases. However, the number of pixels X is appropriately set based on the fibrous degree of binder, which is to be measured, and the data may be trained into the machine learning model 70.

Referring to FIG. 6, a flow of evaluating fiberization of binder according to the present disclosure will be described.

The computer 50 or the storage device 60 is supplied with image data in which the fibrous degree of binder is known at step S10. A feature vector of the image data supplied through image embedding is generated at step S20. The computer 50 is subjected to machine learning by taking the feature vector as an input and taking the indication value n indicating whether the binder is fiberized or the fibrous degree thereof as defined above as an output at step S30. Thus, the evaluation system may determine the fibrous degree of binder in the dry electrode mixture M through the machine learning model 70 using the input image.

At step S40, the dry electrode mixture M is supplied from the manufacturing apparatus 10 through the supply channel 20. The dry electrode mixture M supplied through the supply channel 20 is conveyed to the conveyor 30, which is configured to move at step S50. The conveyor 30 moves, and the microscope 40 is disposed downstream of the supply channel 20 with respect to the flow direction P of the dry electrode mixture M. When the dry electrode mixture M on the conveyor 30 reaches the microscope 40, the movement of the conveyor 30 is stopped for a predetermined time. Then the microscope 40 observes the dry electrode mixture M and obtains the image thereof at step S60.

The obtained image, i.e., the target image to be analyzed, in which whether the binder is fiberized or the fibrous degree thereof is unknown, is transmitted to the computer 50 at step S70. The computer 50 first obtains the feature vector of the target image through image embedding at step S80. Then the computer 50 inputs the feature vector of the target image into the machine learning model 70 and obtains the indication value n indicating the fibrous degree of binder as an output. The computer 50 may determine whether the binder is fiberized or the fibrous degree thereof based on the obtained indication value n at step S90.

The conveyor 30 may be stopped for the predetermined time only when the microscope 40 analyzes the dry electrode mixture M and then be started again. The dry electrode mixture M, which has been analyzed by the microscope 40, is returned to the manufacturing apparatus 10 at step S100. Without consuming the dry electrode mixture for the analysis, the analyzed dry electrode mixture is introduced back into the manufacturing apparatus 10 and used for manufacturing a dry electrode.

The evaluation system according to the present disclosure may be used not only for a lithium-ion battery containing a liquid electrolyte but also for a lithium-metal battery and an all-solid-state battery.

According to the present disclosure, an analysis device, such as a microscope, may be integrated into a manufacturing apparatus of a dry electrode to analyze the fibrous degree of binder in the dry electrode mixture while being manufactured. As a result, time and cost for analysis, and time to reflect analysis results may be greatly reduced.

In addition, the present disclosure may provide immediate feedback during the manufacturing process by evaluating the obtained analysis data using a machine learning model. Therefore, the quality of the dry electrode may be controlled using data, obtained through the microscope and being automatically monitored in real time. Also, when an unexpected range of fiberization is measured, an operator may be notified or feedback may be made by automatically reflecting it in a preceding process. The system according to the present disclosure may be applicable in a smart factory.

Instructions executable by the computer 50 are stored in the storage device 60. In an embodiment of the present disclosure, the instructions may include instructions for executing the operation of the computer 50 and/or the operation of each component of the computer 50.

The storage device 60 may be a volatile memory or a non-volatile memory. As a non-limiting example, the volatile memory may be a dynamic random access memory (DRAM), a static random access memory (SRAM), and the like. As another non-limiting example, the non-volatile memory may be an electrically erasable programmable read-only memory (EEPROM), a flash memory, a magnetic RAM (MRAM), a CD-ROM, a DVD-ROM, and the like.

In addition, the storage device 60 may store a matrix, on which a calculation is to be made, included in the neural network, and may store calculation results generated through processing by the computer 50.

The computer 50 may execute instructions stored in the storage device 60. The computer 50 may execute computer readable codes and instructions stored in the storage device 60. As a non-limiting example, the computer 50 may include a central processing unit, a graphics processing unit, a neural processing unit, a multi-core processor, a multiprocessor, an application-specific integrated circuit (ASIC), and a field programmable gate array (FPGA).

According to the present disclosure, the evaluation system may also be implemented in the form of a recording medium containing instructions executable by a computer, such as program modules executed by a computer. Computer readable media may be any available media accessible by a computer and includes both volatile and non-volatile media, and removable and non-removable media. In addition, the computer readable media may include all computer storage media. The computer storage media includes both volatile and non-volatile media, and removable and non-removable media implemented through computer readable instructions, data structures, program modules, or any method or technology for storage of information such as data.

As is apparent from the above description, the present disclosure provides the following effect.

According to the present disclosure, there is provided an evaluation system for a dry electrode mixture capable of effectively determining whether binder is fiberized or the fibrous degree thereof during manufacturing of a dry electrode.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A system for evaluating a dry electrode mixture, the system comprising:
a manufacturing apparatus configured to form a film of the dry electrode mixture, the dry electrode mixture including an electrode active material, a conductive additive, and a binder;
a microscope configured to obtain a target image of the dry electrode mixture supplied from the manufacturing apparatus; and
a computer operably connected to the microscope, the computer configured to analyze the target image obtained from the microscope and determine whether the binder in the dry electrode mixture is fiberized.

2. The system of claim 1, wherein the computer is configured to output a result indicating whether the binder in the dry electrode mixture is fiberized.

3. The system of claim 2, wherein when the binder is determined to be fiberized, the analyzed dry electrode mixture is introduced back into the manufacturing apparatus and used for manufacturing a dry electrode.

4. The system of claim 1, further comprising a supply channel diverged from the manufacturing apparatus to supply the dry electrode mixture from the manufacturing apparatus to the microscope.

5. The system of claim 4, further comprising a conveyor configured to convey the dry electrode mixture supplied from the supply channel to the microscope.

6. The system of claim 5, wherein the dry electrode mixture corresponding to the target image obtained by the microscope is supplied back to the manufacturing apparatus.

7. The system of claim 1, wherein:
the computer is configured to determine whether the binder is fiberized using a pre-built machine learning model, and
the machine learning model is built by learning information on a plurality of images in which fiberization of the binder is known.

8. The system of claim 7, wherein the machine learning model is configured to receive a feature vector of the target image obtained through image embedding as an input and output an indication value indicating the fiberization of the binder.

9. The system of claim 7, wherein the machine learning model is a logistic regression, a random forest, or a neural network.

10. The system of claim 1, wherein the microscope is an optical microscope or a scanning electron microscope.

11. A battery for a vehicle, the battery being produced by the system of claim 1.

12. A vehicle comprising the battery of claim 11.

13. A system for evaluating a dry electrode mixture, the system comprising:
a microscope configured to obtain a target image of the dry electrode mixture supplied thereto, the dry electrode mixture being a mixture of an electrode active material, a conductive additive, and a binder; and
a computer operably connected to the microscope, the computer configured to receive the target image from the microscope, the computer being configured to analyze the target image obtained from the microscope and determine whether the binder in the dry electrode mixture is fiberized based on the received target image.

14. The system of claim 13, wherein the computer is configured to input data indicating the target image into a pre-built machine learning model to obtain an indication value indicating whether the binder is fiberized.

15. The system of claim 13, wherein the computer is configured to:
obtain a feature vector of the target image through image embedding,
input the feature vector into a pre-built machine learning model to obtain an indication value indicating fiberization of the binder, and
determine whether the binder is fiberized based on the indication value.

16. The system of claim 15, wherein the machine learning model is built by learning information on a plurality of images in which whether the binder in the dry electrode mixture is fiberized is known.

17. The system of claim 16, wherein the machine learning model is configured to, in the plurality of images indicated as feature vectors of the images, learn a first indication value when the binder has a thickness within a first range and a second indication value when the binder has a thickness within a second range.

18. The system of claim 17, wherein the computer is configured to, by the machine learning model:
determine that the binder is not fiberized when the first indication value is obtained for the target image, and
determine that the binder is fiberized when the second indication value is obtained for the target image.

19. The system of claim 13, wherein the computer is configured to divide the obtained target image into a plurality of pixels and determine whether the binder is fiberized based on an area of the binder occupying the plurality of pixels.

20. The system of claim 19, wherein the computer is configured to:
determine a number of binders in the target image based on pixel sections where the binder is continuously present in the target image, and
determine a fibrous degree of the binder based on an average value obtained by dividing a number of the pixels occupying the pixel section in the target image by the number of binders.
